(19) United States
(12) Patent Application Publication
(10) Pub. No.: US 2025/0253938 A1
(43) Pub. Date: Aug. 7, 2025

(54) APPARATUS AND METHOD FOR SUPPORTING IDENTIFICATION OF ON-BOARD BASE STATION IN WIRELESS COMMUNICATION SYSTEM

(71) Applicant: LG ELECTRONICS INC., Seoul (KR)

(72) Inventors: Jaemin HAN, Seoul (KR); Daewook BYUN, Seoul (KR); Seokjung KIM, Seoul (KR)

(73) Assignee: LG ELECTRONICS INC., Seoul (KR)

(21) Appl. No.: 19/035,529

(22) Filed: Jan. 23, 2025

Related U.S. Application Data
(60) Provisional application No. 63/550,044, filed on Feb. 6, 2024.

(51) Int. Cl. H04B 7/185

(52) U.S. Cl. CPC H04B 7/18558; H04B 7/18521; H04B 7/18545

(57) ABSTRACT

According to at least one embodiment, a method of operating a Next Generation (NG) Node B (gNB) on board a non-terrestrial satellite includes: establishing a physical layer connection to a non-terrestrial network (NTN) gateway for an NG Application Protocol (NGAP) connection; establishing a transport layer protocol connection to a 5G core network (5GC) for the NGAP connection; determining that the NGAP connection is to become nonoperational or unavailable; and, in response to the determination, transmitting a message to indicate that the NGAP connection is to become nonoperational or unavailable.

### CROSS-REFERENCE TO RELATED APPLICATION(S)

Pursuant to 35 U.S.C. § 119, this application claims the benefit of earlier filing date of Provisional Application No. 63/550,044, filed on Feb. 6, 2024, the contents of which are hereby incorporated by reference herein in its entirety.

### BACKGROUND

The 3^{rd} Generation Partnership Project (3GPP) has discussed non-terrestrial networks (NTNs) for enabling connectivity between terrestrial systems and satellite systems on the same mobile platform.

Such networks (or segments of networks) may use satellites in different constellations to carry, for example, a transmission equipment relay node. Such satellites may include Low Earth Orbit (LEO) satellites that typically operate at altitudes of approximately 400 to 2,000 kilometers (km), Medium Earth Orbit (MEO) satellites that typically operate at altitudes 8,000 to 20,000 km, and Geostationary Earth Orbit (GEO) satellites that typically operate at altitudes of approximately 36,000 km above the Earth's equator.

Initial efforts in developing NTNs have focused on mobile broadband (MBB) and Internet of Things (IoT) use cases, which present lighter communicational/computational burdens on node equipment that is carried onboard satellites.

### SUMMARY

Aspects of the present disclosure are directed to supporting usage of node equipment that is carried by a satellite in a 5^{th} Generation (5G) system. For example, particular aspects are directed to facilitating identification or recognition of a next-generation (NG) Node B (gNB) as being a gNB that is carried by a satellite (a spaceborne gNB, or a satellite onboard gNB).

NTNs may include regenerative payload architectures that utilize such gNBs. Because such architectures may pose unique operational considerations, it may be important to recognize whether a particular gNB is (or is not) carried by a satellite. This may be especially important in NTNs that include mixed deployments, e.g., a combination of spaceborne gNBs and terrestrial gNBs.

The present disclosure relates to a method and apparatus for identifying a base station carried by a satellite in a wireless communication system.

The present disclosure relates to a method and apparatus for configuring information indicating a spaceborne base station in a wireless communication system.

The present disclosure relates to a method and apparatus for transmitting information indicating that a base station is the spaceborne base station in a wireless communication system.

The present disclosure relates to a method and apparatus for identifying a satellite-onboard base station using node-level signaling in a wireless communication system.

The present disclosure relates to a method and apparatus for identifying a satellite-onboard base station using UE-related signaling through a already established NG protocol connection in a wireless communication system.

The present disclosure relates to a method and apparatus for determining that an NGAP connection is to become nonoperational or unavailable in a wireless communication system.

The present disclosure relates to a method and apparatus for transmitting a message indicating that an NGAP connection is to become nonoperational or unavailable in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

According to at least one embodiment, a method of operating a Next Generation (NG) Node B (gNB) on board a non-terrestrial satellite includes: establishing a physical layer connection to a non-terrestrial network (NTN) gateway for an NG Application Protocol (NGAP) connection; establishing a transport layer protocol connection to a 5G core network (5GC) for the NGAP connection; determining that the NGAP connection is to become nonoperational or unavailable; and, in response to the determination, transmitting a message to indicate that the NGAP connection is to become nonoperational or unavailable.

According to at least one embodiment, a method of operating a network node of a 5G core network (5GC) includes: establishing a transport layer protocol connection to a Next Generation (NG) Node B (gNB) on board a non-terrestrial satellite for an NG Application Protocol (NGAP) connection, the NGAP connection including a physical layer connection established between the NTN gateway and the gNB; and receiving, from the gNB, a message indicating that the NGAP connection is to become nonoperational or unavailable.

According to at least one embodiment, a Next Generation (NG) Node B (gNB) for operation on board a non-terrestrial satellite includes: at least one transceiver; and at least one processor configured to: establish a physical layer connection to a non-terrestrial network (NTN) gateway for an NG Application Protocol (NGAP) connection; establish a transport layer protocol connection to a 5G core network (5GC) for the NGAP connection; determine that the NGAP connection is to become nonoperational or unavailable; and in response to the determination, transmit a message to indicate that the NGAP connection is to become nonoperational or unavailable.

According to at least one embodiment, a communication apparatus may include at least one processor and at least one computer memory connected to the at least one processor to store instructions directing operations when executed by the at least one processor. The operations may include establishing a physical layer connection to a non-terrestrial network (NTN) gateway for an NG Application Protocol (NGAP) connection; establishing a transport layer protocol connection to a 5G core network (5GC) for the NGAP connection; determining that the NGAP connection is to become nonoperational or unavailable; and, in response to the determination, transmitting a message to indicate that the NGAP connection is to become nonoperational or unavailable.

According to at least one embodiment, a non-transitory computer-readable medium storing at least one instruction may comprise the at least one instruction that is executable by a processor. The at least one instruction may control a device to establish a physical layer connection to a non-terrestrial network (NTN) gateway for an NG Application Protocol (NGAP) connection; establish a transport layer protocol connection to a 5G core network (5GC) for the NGAP connection; determine that the NGAP connection is to become nonoperational or unavailable; and in response to the determination, transmit a message to indicate that the NGAP connection is to become nonoperational or unavailable.

The following effects may be produced by embodiments based on the present disclosure.

The present disclosure enables identification of a spaceborne gNB in a wireless communication system.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings, which are included to provide a further understanding of the disclosure, illustrate embodiments of the disclosure and together with the description serve to explain aspects of the disclosure:

FIG. 1 is a diagram illustrating the structure of a new radio (NR) system;

FIG. 2 is a diagram illustrating a functional split between a next generation radio access network (NG-RAN) and a 5th generation core network (5GC);

FIG. 3A and FIG. 3B illustrate a radio protocol architecture of the NR system;

FIG. 4 illustrates an example of a Non-Terrestrial Network (NTN) for providing non-terrestrial NR access via a transparent payload architecture;

FIG. 5 illustrates an example of an NTN for providing non-terrestrial NR access via a regenerative payload architecture; and

FIG. 6 illustrates a procedure involving a satellite onboard gNB according to at least one embodiment.

FIG. 7 illustrates a flowchart of a method of operating a Next Generation (NG) Node B (gNB) on board a non-terrestrial satellite according to at least one embodiment.

FIG. 8 illustrates a flowchart of a method of operating a network node of a 5G core network (5GC) according to at least one embodiment.

### DETAILED DESCRIPTION

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

As more and more communication devices require greater communication capacity, there is a growing need for enhanced Mobile Broadband (eMBB) Communications improved over the current radio access technology (RAT). In addition, massive Machine Type Communications (MTC) that connects numerous devices and objects to provide various services anytime and anywhere is also considered a key issue in next-generation communications. Additionally, discussions are underway regarding communication system designs in consideration of services and/or UEs sensitive to reliability and latency. The introduction of next-generation RATs such as eMBB, massive MTC, Ultra Reliable and Low Latency Communications (URLLC) is being discussed. In this document, the corresponding technology will be referred to as New Radio or New RAT (NR) for convenience of description.

For the sake of clarity, the disclosure primarily focuses on 3GPP NR, but the technical ideas of the disclosure are not limited thereto.

In this specification, the term “set/setting” may be replaced with the term “configure/configuration”, and both terms may be used interchangeably. A conditional expression (e.g., “if”', “in a case”, or “when”) may be replaced by “based on that” or “in a state/status.” In addition, operations and software/hardware (SW/HW) configurations of a user equipment/base station (UE/BS) may be derived/understood based on satisfaction of related conditions. If a process on a receiving (or transmitting) side is capable of being derived/understood from a process on a transmitting (or receiving) side in signal transmission/reception between wireless communication devices (e.g., BS, UE, etc.), description thereof may be omitted. Signal determination/generation/encoding/transmission at the transmitting side, for example, may be understood as signal monitoring reception/decoding/determination at the receiving side. When it is said that the UE performs (or does not perform) a specific operation, it may be interpreted to mean that the BS expects/assumes (or does not expect/assume) that the UE will perform the specific operation. When it is said that the BS performs (or does not perform) a specific operation, it may be interpreted to mean that the UE expects/assumes (or does not expect/assume) that the BS will perform the specific operation. In the following description, the classification and indexing of sections, embodiments, examples, options, methods, schemes, and so on are merely for convenience of description, but it does not imply that each necessarily constitutes an independent disclosure or should be implemented separately. Furthermore, in describing each section, embodiment, example, option, method, solution, and so on if there is no explicit conflict, it may be inferred or understood that at least some of the sections, embodiments, examples, options, methods, solutions, and so on may be implemented in combination or may be omitted in implementation.

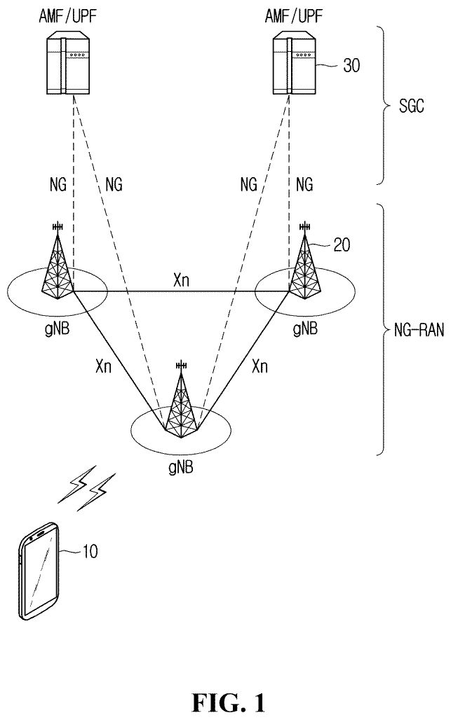

FIG. 1 illustrates the structure of a NR system.

Referring to FIG. 1, a next-generation radio access network (NG-RAN) may include a BS 20 that provides user plane and control plane protocol termination to a UE 10. For example, the BS 20 may include a next-generation Node B (gNB) and/or an evolved Node B (eNB). The UE 10 may have fixed or mobile characteristics. The UE 10 may be referred to by other terms such as a mobile station (MS), user terminal (UT), subscriber station (SS), mobile terminal (MT), or wireless device. For example, the BS 20 may be a fixed station communicating with the UE 10. The BS 20 may be referred to by other terms such as a base transceiver system (BTS), access point, and so on.

FIG. 1 shows an example in which a gNB alone is included (in the BS 20). The BSs 20 may be connected to each other via an Xn interface. The BS 20 may be connected to a 5th generation core network (5GC) via an NG interface. Specifically, the BS 20 may be connected to an access and mobility management function (AMF) 30 through an NG-C interface and connected to a user plane function (UPF) 30 through an NG-U interface.

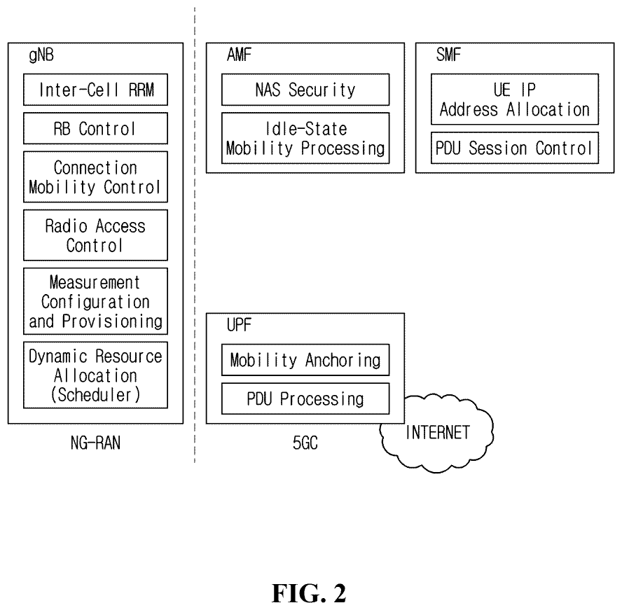

FIG. 2 illustrates functional split between the NG-RAN and the 5GC.

Referring to FIG. 2, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

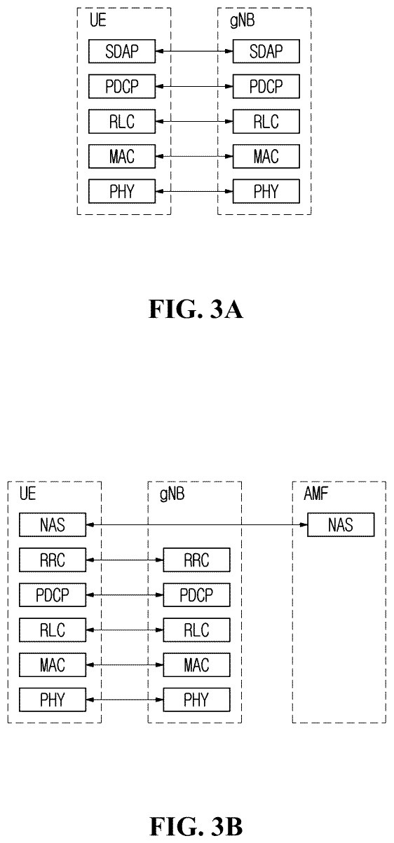

FIG. 3A and FIG. 3B illustrate a radio protocol architecture of the NR system. Specifically, FIG. 3A illustrates a user-plane radio protocol architecture, and FIG. 3B illustrates a control-plane radio protocol architecture. A user plane is a protocol stack for user data transmission, and a control plane is a protocol stack for control signal transmission.

Referring to FIG. 3A and FIG. 3B, the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

A service data adaptation protocol (SDAP) layer is only defined in the user plane. The SDAP layer performs functions such as mapping between QoS flows and data radio bearers as well as marking QoS flow identifiers (IDs) within DL and UL packets.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

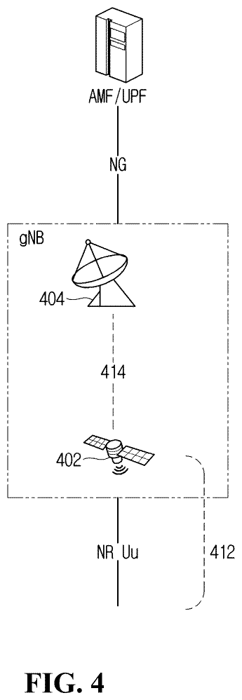

FIG. 4 illustrates an example of a Non-Terrestrial Network (NTN) for providing non-terrestrial NR access via a transparent payload architecture.

Such an architecture employs a non-regenerative payload, which is a platform carried by a satellite and having no on-board processing capabilities for, e.g., demodulation/decoding, switching and/or routing, coding/modulation, etc. Rather, the non-regenerative payload operates similarly to an analogue radio frequency (RF) repeater: the non-regenerative payload converts the frequency carrier of a received uplink RF signal, and filters and amplifies the signal before transmitting it on the downlink. In other words, the only processing that can be performed onboard the satellite is RF processing such as frequency conversion, amplification and beam management.

With continued reference to FIG. 4, a non-regenerative payload 402 is carried by a satellite. The non-regenerative payload 402 receives radio protocol from, for example, a UE via a service link 412. The non-regenerative payload 402 may perform the frequency conversion, filtering and amplification functions noted earlier. After performing such functions, the non-regenerative payload 402 may transparently forward the resulting signal to a terrestrial NTN gateway 404 via a feeder link 414.

Similarly, the non-regenerative payload 402 may receive radio protocol from the NTN gateway 404 via the feeder link 414. The non-regenerative payload 402 may perform the frequency conversion, filtering and amplification functions noted earlier. After performing such functions, the non-regenerative payload 402 may transparently forward the resulting signal to, for example, a UE via the service link 412.

It is understood that the NG interface termination of NG-RAN servicing NTN services with 5GC may be similar to that of a terrestrial network on the ground.

In performing the noted functions, the non-regenerative payload 402 serves merely as an RF relay. As such, relatively light communicational/computational burdens are imposed on the non-regenerative payload 402.

With respect to the transparent payload architecture of FIG. 4, characteristics that have been addressed include the following: mitigation of longer propagation delay and reduced uplink coverage over the Uu interface; large beam footprint of the transparent payload and wide cell coverage (that may span over multiple countries); mobility challenges; accommodation of large doppler shifts; ensuring of seamless service continuity through terrestrial networks due to time-varying cell coverages and gaps; and expansions of NTN operating frequency bands (e.g., for service coverage/capability extensions).

Aspects of the present disclosure are directed to an NTN using a regenerative payload architecture (e.g., instead of or, in addition to, a transparent payload architecture). Unlike the non-regenerative payload 402 of FIG. 4, a payload of a regenerative payload architecture is capable of performing processes such as those typically performed by a base station (e.g., modulation/demodulation, encoding/decoding, switching/routing, management of NG/Xn interfaces and UE contexts, RRM, etc.) As such, decoding and processing of packets can be performed onboard the satellite. Such functionalities are in addition to the RF processing capabilities described earlier with respect to the non-regenerative payload 402 of FIG. 4.

Providing shorter delays over the Uu interface and much higher performance capability, the regenerative payload architecture aims to further expand the NTN service capabilities and coverages for more advanced use cases.

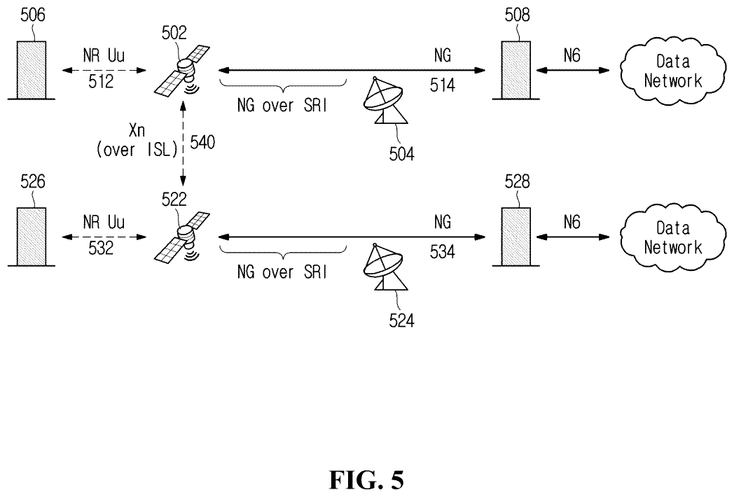

FIG. 5 illustrates an example of an NTN for providing non-terrestrial NR access via a regenerative payload architecture. Such an architecture employs one or more regenerative payloads (e.g., gNB 502, gNB 522) that are onboard one or more satellites. The regenerative payloads implement regeneration of signals received from Earth.

With reference to FIG. 5, a NR-Uu radio interface is provided on a service link 512 between a UE 506 and the gNB 502. A satellite radio interface (SRI) is provided between the gNB 502 and an NTN gateway 504. The NTN gateway 504 is a Transport Network Layer node, and supports all necessary transport protocols. The SRI is a feeder link between the gNB 502 and the NTN gateway 504. The gNB 502 may be connected to a 5GC 508 via the NG interface 514.

Similarly, a NR-Uu radio interface is provided on a service link 532 between a UE 526 and the gNB 522. An SRI is provided between the gNB 522 and an NTN gateway 524. The NTN gateway 524 is a Transport Network Layer node, and supports all necessary transport protocols. The SRI is a feeder link between the gNB 522 and the NTN gateway 524. The gNB 522 may be connected to a 5GC 528 via the NG interface 534.

With continued reference to FIG. 5, respective satellites carrying the gNB 502 and the gNB 522 may communicate via the Xn interface over an Inter-Satellite Link (ISL) 540 between the satellites. The ISL is a transport link between the satellites. By way of example, the ISL 540 may be a radio interface or an optical interface.

The regenerative payload architecture of FIG. 5 that includes spaceborne gNBs may be used to enhance NTN capabilities. Aspects of the present disclosure are directed to supporting usage of regenerative payloads. For example, particular aspects are directed to facilitating identification or recognition of a gNB (e.g., gNB 502, 522) as being a gNB that is carried by a satellite. The facilitating may occur via one or more messages that are communicated in a NR and/or a NG-RAN.

A regenerative payload architecture may pose issues that do not arise in the transparent payload architecture of FIG. 4. Such issues relate to, e.g., longer NG interface delays, connectivity variations, and potentially limited NG Application Protocol (NGAP) functions due to space-related constraints.

Regarding interface delays, due to the gNB being onboard a satellite, communications via the NG interface (e.g., over the feeder link via NTN gateway 504) are expected to experience longer delays. Such delays would not have been present in a transparent payload architecture in which it is assumed that the NG interface termination with the 5GC is on the ground, similar to a terrestrial network. As such, relevant timers in NGAP may need to be adjusted/adapted differently.

Regarding connectivity variations, NG connectivity from a spaceborne gNB should not necessarily be handled similarly to legacy NG connectivity from a gNB in a terrestrial network, or to NG connectivity from an NTN gNB (of a transparent payload) that is located on the ground. In a regenerative payload architecture, NG connections necessarily traverse through space (e.g., over the feeder link or the ISL 540). This may pose challenges related to, for example, frequent/dynamic changes in connectivity with NTN gateways (e.g., as the orbit of a particular satellite causes line-of-sight with respect to a first NTN gateway to be lost, and causes line-of-sight with respect to a differently located second NTN gateway to appear or reappear) and increased likelihood of outages.

Regarding potential limitations with respect to NGAP functions, not all NGAP functions may be supported for spaceborne gNBs due to their power/processing constraints and limited feeder link transport capability (compared to those of a gNB in a terrestrial network or a transparent payload architecture).

On the other hand, due to reductions in the propagation delay over the Uu interface, features that had been developed for transparent payloads to mitigate challenges over the Uu interface (see, e.g., service link 412 of FIG. 4) may no longer be deemed necessary.

Aspects of the present disclosure are directed to facilitating distinguishing spaceborne gNBs from gNBs that are not carried by satellites in 5G systems. gNBs that are not carried by satellites include, e.g., NTN gNBs supporting transparent payload architectures, and gNBs in purely terrestrial systems. Such aspects may be especially important in mixed deployments, involving spaceborne gNBs as well as gNBs that are not carried by satellites. As detailed earlier, regenerative payload architecture may pose issues relating to, e.g., longer NG interface delays, connectivity variations, and potentially limited NGAP functions due to space-related constraints. Such issues can be better addressed based on recognizing that a particular gNB is carried by a satellite.

However, 3GPP specifications lack mechanisms for enabling such differentiation in 5G systems. By way of example, RAT type information that is provided per tracking area over NGAP does not specify, for example, whether a particular gNB is carried by a satellite, or is on the ground supporting NTN services via a transparent payload(s). As such, during operation of a 5G system, a gNB of the former type is not readily distinguishable (or recognizable) from a gNB of the latter type.

Aspects of the present disclosure are directed to mechanisms for facilitating the identification of a gNB in a 5G system as being a spaceborne gNB. Aspects will be described herein with reference to node-level signaling. In addition, aspects will be described herein with reference to UE-related signaling.

The former will be described in more detail first. In this regard, node-level signaling may be configured (or provided) to the spaceborne gNB. Alternatively (or in addition), the node-level signaling may be initiated by the spaceborne gNB.

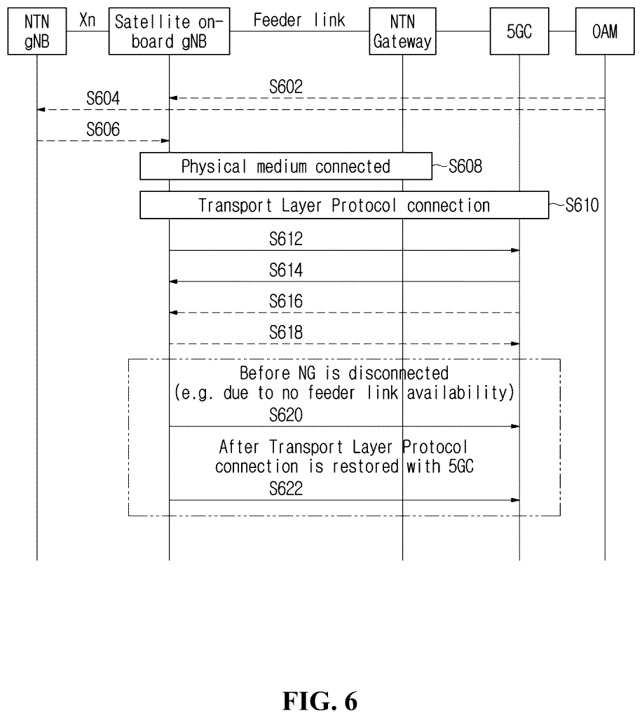

By way of example, according to at least one embodiment, after the physical layer and/or transport network layer connection is successfully established with the 5GC, the spaceborne gNB may initiate NGAP connection setup using information that indicates the gNB as being spaceborne. Such features and other features will be described in more detail with reference to FIG. 6.

FIG. 6 illustrates a procedure involving a spaceborne gNB (satellite on-board gNB), a neighboring NTN gNB, an NTN Gateway, a 5GC, and an OAM (Operation, Administration, Maintenance) according to at least one embodiment.

Before deployment of the gNB that will be spaceborne, the gNB (see, e.g., gNB 502 of FIG. 5) may be pre-configured with specific transport layer protocol related information dedicated for NGAP signaling (e.g., destination IP address, port number, or payload protocol identifier (PPID) if Stream Control Transmission Protocol (SCTP) is used, etc.). The gNB may be pre-configured with a specific gNB ID that identifies the gNB as being a spaceborne gNB. Such an ID may be one of multiple IDs that are specifically reserved for gNBs that are (or will be) spaceborne.

According to at least one embodiment, the satellite on-board gNB may be pre-configured with such information by OAM before the satellite carrying the gNB is deployed (see, e.g., S602 of FIG. 6).

Alternatively, such information may be communicated to a neighboring NTN gNB (see, e.g., S604 of FIG. 6). At S606, the spaceborne gNB (see, e.g., gNB 502 of FIG. 5) may be configured with such information through an Xn connected neighboring NTN gNB (see, e.g., gNB 522) after deployment of the spaceborne gNB.

At S608, the spaceborne gNB (see, e.g., gNB 502 of FIG. 5) establishes a physical layer connection to (or with) the NTN gateway (see, e.g., NTN gateway 504). The physical layer connection may be established for an NGAP connection.

At S610, the spaceborne gNB establishes a transport layer protocol connection to (or with) the 5GC (e.g., AMF of 5GC 508 of FIG. 5) for setup of the NGAP connection. Here, if specific transport layer protocol related information had been standardized or pre-configured (see, e.g., S602 or S604), such information may be used by the 5GC to identify the gNB as being a spaceborne gNB.

After the transport network becomes operational with the 5GC (e.g., after the transport layer protocol connection is established), the spaceborne gNB initiates NG connection setup. For example, at S612, the satellite on-board gNB transmits, to the 5GC, a setup message (e.g., NG SETUP REQUEST message) to initiate NGAP connection setup. The setup message may include information indicating (or representing) that the gNB is a spaceborne gNB.

For example, the NG SETUP REQUEST message may include the specific gNB ID described earlier with reference to S602 and S604.

Alternatively, the NG SETUP REQUEST message may include an explicit indicator (e.g., a binary indicator) that is recognizable by the 5GC as indicating that the gNB is a spaceborne gNB.

Alternatively, the NG SETUP REQUEST message may include information regarding a feeder link availability time. Such information may also be recognizable by the 5GC as indicating that the gNB is spaceborne. As described earlier regarding frequent/dynamic changes in connectivity with NTN gateways, the orbit of a satellite may cause line-of-sight with respect to NTN gateways to be lost and regained over time (e.g., over the trajectory of the orbit). The feeder link availability time may be based on a pre-planned trajectory and location/coverage of NTN gateway(s) for NG connectivity.

At S614, the satellite on-board gNB receives, from the 5GC, a response message (e.g., NG SETUP RESPONSE message) in response to the setup message of S612. The response message may acknowledge that the setup message was received by the 5GC.

For the spaceborne gNB, the AMF (of the 5GC) may initiate an update of NGAP application configuration data. The initiation may include transmitting a configuration message that includes, for example, specific transport protocol layer related information to be used by the satellite on-board gNB for future NG connection setup. For example, such updated information may be for use in place of similar information described earlier with reference to S602 and S604.

For example, at S616, the spaceborne gNB may receive, from the 5GC, a configuration message (e.g., AMF CONFIGURATION UPDATE message). The configuration message may include transport protocol layer-related information (e.g., destination IP address, port number, or payload protocol identifier (PPID) if Stream Control Transmission Protocol (SCTP) is used, etc.) to be used for a future NGAP connection. For example, such information may be for use in a future transmission of a setup message similar to the setup message described earlier with reference to S612.

At S618, the spaceborne gNB transmits, to the 5GC, an acknowledgment in response to receiving the configuration message of S616. The acknowledgment message may acknowledge that the configuration message was received by the spaceborne gNB.

During operation, the spaceborne gNB may determine that the NGAP connection is to become nonoperational (or unavailable). For example, such determination may be based on the feeder link availability time described earlier with reference to S612. As such, the determination may be based on known information regarding pre-planned trajectory and location/coverage of NTN gateway(s) for NG connectivity.

Alternatively (or in addition), the determination may be based on measurements of feeder link quality and comparisons of such measurements against one or more thresholds. For example, the feeder link quality may degrade prior to the trajectory of the satellite causing NG connection to an NTN gateway to become lost. If the measured quality falls below one or more threshold values, the spaceborne gNB may determine that the NGAP connection is to become nonoperational (or unavailable). The values of such thresholds may be preconfigured or updated by the 5GC.

Before the NG interface is disconnected (e.g., due to no feeder link availability), the spaceborne gNB may initiate an NGAP procedure to inform the 5GC that the NG connection will be lost (see S620 of FIG. 6). For example, in response to determining that the NGAP connection is to become nonoperational (or unavailable), the spaceborne gNB transmits a message (e.g., NG CONNECTION LOST START message or NG REMOVAL REQUEST message or NG SUSPEND REQUEST message) to the 5GC, to indicate that the NGAP connection is to become nonoperational. The message is transmitted to indicate, for example, that the NGAP connection is to be lost, released or suspended

As a result of transmitting the message of S620, the NG connection may be released or suspended.

Once the transport network with the 5GC becomes operational once again, the spaceborne gNB may initiate an NGAP procedure to inform the 5GC that the NG connection has become available. This is so that the NG connection may be reestablished or resumed. For example, at S622, the spaceborne gNB transmits, to the 5GC, a message (e.g., NG CONNECTION LOST STOP message or NG SETUP REQUEST message or NG RESUME REQUEST message) in response to the transport network becoming operational once again. As such, the NG connection may be reestablished or resumed.

As described earlier with reference to various embodiments (see, e.g., FIG. 5 and FIG. 6), particular aspects of the disclosure are directed to facilitating identification or recognition of a gNB as being a spaceborne gNB, via one or more messages that are communicated in a NR and/or a NG-RAN. In at least one embodiment, a 5GC may be configured to identify a gNB as being spaceborne based on observations made by the 5GC. Such observations may support a determination that the gNB is spaceborne.

For example, as described earlier, NG connection from a gNB carried by a satellite may often (or periodically) be released/re-established, or suspended/resumed due to the movement of the satellite and feeder link availability with NTN gateway(s) on the ground. Such changes with respect to NG connectivity may be initiated by the satellite on-board gNB.

The 5GC may be configured to recognize such activity as being characteristic of a gNB that is operating in space, and identify the gNB as being spaceborne based on such activity.

Aspects of the present disclosure will now be described in more detail with reference to UE-related signaling.

Such signaling may be performed with respect to a UE that is served by a spaceborne gNB over an NG protocol connection that is already established. For example, after the physical layer, transport network layer, and NG protocol connections are successfully established with a 5GC, the spaceborne gNB may send information indicating that the gNB is on-board a satellite. Such information may be sent via UE-related signalings served through the satellite.

According to at least one embodiment, such indication could be delivered via a PDU session related NGAP signaling of the UE, or via piggy-back onto data of the UE that is sent from the gNB to the 5GC over NG-U. As such, the indication can be transparently forwarded to a proper entity or function in the 5GC (e.g., SMF or UPF) that may require differentiated handlings of PDU session and/or QoS flows for UE(s) served through the spaceborne gNB.

According to at least one embodiment, a message (e.g., NGAP INITIAL UE MESSAGE) may include such an indication. Through such a message, initial location information of the UE is also provided to the 5GC. In a legacy (non-NTN) system, the accessed cell, selected PLMN and the associated tracking area (i.e., single tracking area) of the UE are sent to the 5GC. In an NTN system that employs a transparent payload, the location information is extended to supply one or more tracking areas associated with the accessed cell, because coverage of a single cell as provided by a satellite is wider and may span across multiple tracking areas. However, such extension, alone, does not specify whether a particular gNB is onboard a satellite or is on the ground supporting NTN services via a transparent payload(s).

According to at least one embodiment, the message (e.g., NGAP INITIAL UE MESSAGE) informs the AMF that a particular gNB is onboard a satellite. Once the AMF becomes aware that the gNB is on-board the satellite, the AMF may communicate this information to other entities or functions in the 5GC, e.g., entities or functions that may need to provide differentiated handling of services for the UE(s) served through the spaceborne gNB.

According to at least one embodiment, another NGAP UE-associated signaling message can be used to carry such an indication.

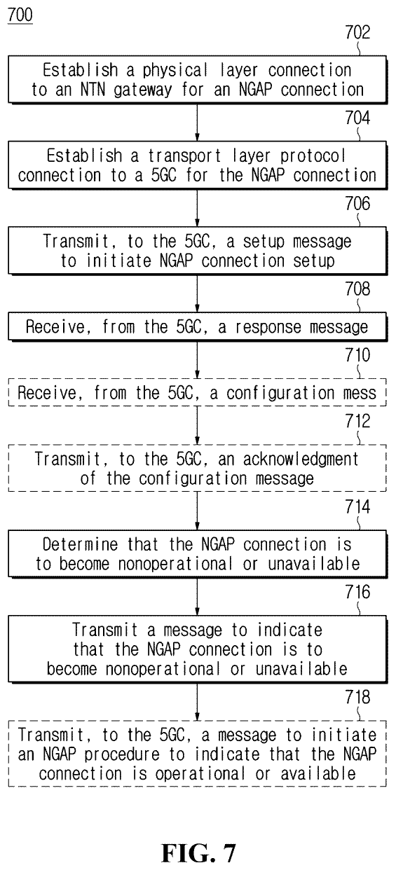

FIG. 7 illustrates a flowchart of a method 700 of operating a gNB on board a non-terrestrial satellite according to at least one embodiment.

The gNB may be pre-configured with information indicative of a spaceborne gNB before deployment of the non-terrestrial satellite. By way of example, the information indicative of the spaceborne gNB may include at least a specific gNB ID that is reserved for use by spaceborne gNBs.

For example, identification of the gNB by a 5GC as being a spaceborne gNB may be based on pre-configured transport layer protocol-related information.

Alternatively (or in addition), the gNB may be configured with information indicative of a spaceborne gNB after deployment of the non-terrestrial satellite.

At block 702, a physical layer connection to an NTN gateway for an NGAP connection is established.

For example, with reference back to S608 of FIG. 6, the gNB (see, e.g., gNB 502 of FIG. 5) establishes a physical layer connection to (or with) the NTN gateway (see, e.g., NTN gateway 504). The physical layer connection may be established for an NGAP connection.

At block 704, a transport layer protocol connection to a 5GC for the NGAP connection is established.

For example, with reference back to S610 of FIG. 6, the gNB establishes a transport layer protocol connection to (or with) the 5GC (e.g., AMF of 5GC 508 of FIG. 5) for setup of the NGAP connection.

At block 706, a setup message to initiate NGAP connection setup may be transmitted to the 5GC. The setup message include information related to a spaceborne gNB.

For example, with reference back to S612 of FIG. 6, the gNB transmits, to the 5GC, a setup message (e.g., NG SETUP REQUEST message) to initiate NGAP connection setup. The setup message may include information indicating (or representing) that the gNB is a spaceborne gNB.

At block 708, a response message may be received from the 5GC, in response to setup message of block 706.

For example, with reference back to S614 of FIG. 6, the gNB receives, from the 5GC, a response message (e.g., NG SETUP RESPONSE message) in response to the setup message of S612. The response message may acknowledge that the setup message was received by the 5GC.

At block 710, a configuration message may be received from the 5GC. The configuration message may include transport protocol layer-related information for a future NGAP connection.

For example, with reference back to S616 of FIG. 6, the gNB may receive, from the 5GC, a configuration message (e.g., AMF CONFIGURATION UPDATE message). The configuration message may include transport protocol layer-related information (e.g., destination IP address, port number, or payload protocol identifier (PPID) if Stream Control Transmission Protocol (SCTP) is used, etc.) to be used for a future NGAP connection.

At block 712, an acknowledgment message of the configuration message of block 710 may be transmitted to the 5GC.

For example, with reference back to S618 of FIG. 6, the gNB transmits, to the 5GC, the acknowledgment message in response to receiving the configuration message of S616. The acknowledgment message may acknowledge that the configuration message was received by the gNB.

At block 714, it is determined that the NGAP connection is to become nonoperational or unavailable.

For example, as described earlier with reference to FIG. 6, during operation, the gNB may determine that the NGAP connection is to become nonoperational (or unavailable). For example, such determination may be based on a feeder link availability time. As such, the determination may be based on known information regarding pre-planned trajectory and location/coverage of NTN gateway(s) for NG connectivity.

The determination may be based on at least one of location information of the non-terrestrial satellite or location information of one or more NTN gateways preconfigured or updated by the 5GC.

Alternatively (or in addition), the determination may be based on at least one of measurements of feeder link quality or corresponding thresholds preconfigured or updated by the 5GC.

At block 716, a message to indicate that the NGAP connection is to become nonoperational or unavailable is transmitted.

For example, with reference back to S620 of FIG. 6, the gNB transmits a message (e.g., NG CONNECTION LOST START message or NG REMOVAL REQUEST message or NG SUSPEND REQUEST message) to the 5GC, to indicate that the NGAP connection is to become nonoperational. The message is transmitted to indicate, for example, that the NGAP connection is to be lost, released or suspended.

At block 718, in response to the NGAP connection becoming operational or available, a message may be transmitted, to the 5GC, to initiate an NGAP procedure. The message may indicate that the NGAP connection is operational or available so that the NGAP connection may be reestablished or resumed.

For example, with reference back to S622 of FIG. 6, the gNB transmits, to the 5GC, a message (e.g., NG CONNECTION LOST STOP message or NG SETUP REQUEST message or NG RESUME REQUEST message) in response to the transport network becoming operational once again. As such, the NG connection may be reestablished or resumed.

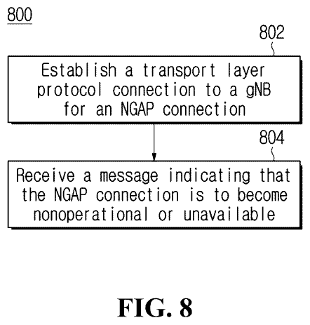

FIG. 8 illustrates a flowchart of a method of operating a network node of a 5G core network (5GC) according to at least one embodiment.

At block 802, a transport layer protocol connection to a gNB for an NGAP connection is established.

For example, with reference back to S610 of FIG. 6, the 5GC (e.g., AMF of 5GC 508 of FIG. 5) establishes a transport layer protocol connection to (or with) a gNB (see, e.g., gNB 502 of FIG. 5) for an NGAP connection.

The NGAP connection includes a physical layer connection established between an NTN gateway (see, e.g., NTN gateway 504) and the gNB,

At block 804, the 5GC receives a message indicating that the NGAP connection is to become nonoperational or unavailable is transmitted.

For example, with reference back to S620 of FIG. 6, the 5GC receives a message (e.g., NG CONNECTION LOST START message or NG REMOVAL REQUEST message or NG SUSPEND REQUEST message) from the gNB, the message indicating that the NGAP connection is to become nonoperational.

The message may be received after the gNB determines that the NGAP connection is to become nonoperational (or unavailable). For example, as described earlier with reference to FIG. 6, during operation, the gNB may make such a determination. Such determination may be based on a feeder link availability time. As such, the determination may be based on known information regarding pre-planned trajectory and location/coverage of NTN gateway(s) for NG connectivity.

The determination may be based on at least one of location information of the non-terrestrial satellite or location information of one or more NTN gateways preconfigured or updated by the 5GC.

Alternatively (or in addition), the determination may be based on at least one of measurements of feeder link quality or corresponding thresholds preconfigured or updated by the 5GC.

The above-described embodiments are combinations of the components and features of the disclosure in specific forms. Each component or feature should be considered optional unless explicitly mentioned otherwise. Each component or feature may be implemented without being combined with other elements or features. Furthermore, some components and/or features may be combined to implement embodiments of the disclosure. The order of operations described in the embodiments of the disclosure may be rearranged. Some components or features of one embodiment may be included in another embodiment, or the components or features may be replaced with related components or features of the other embodiment. It is obvious that claims that are not explicitly cited in the appended claims may be combined to form an embodiment or included as a new claim by amendment after filing.

It is evident to those skilled in the art that the disclosure could be realized in various specific forms within the scope of the features of the disclosure. Therefore, the detailed description above should not be interpreted restrictively in all respects but should be considered as illustrative. The scope of the disclosure should be determined by a reasonable interpretation of the appended claims, and all changes within the equivalent scope of the disclosure are encompassed within the scope of the disclosure.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

What is claimed is:

1. A method comprising:
establishing, by a Next Generation (NG) Node B (gNB) on board non-terrestrial satellite, a physical layer connection to a non-terrestrial network (NTN) gateway for an NG Application Protocol (NGAP) connection;
establishing, by the gNB, a transport layer protocol connection to a 5G core network (5GC) for the NGAP connection;
determining, by the gNB, that the NGAP connection is to become nonoperational or unavailable; and
in response to the determination, transmitting, by the gNB, a message to indicate that the NGAP connection is to become nonoperational or unavailable.

2. The method of claim 1, wherein the message is transmitted to indicate that the NGAP connection is to be lost, released or suspended.

3. The method of claim 1, wherein the determination is based on at least one of location information of the non-terrestrial satellite or location information of one or more NTN gateways preconfigured or updated by the 5GC.

4. The method of claim 1, wherein the determination is based on at least one of measurements of feeder link quality or corresponding thresholds preconfigured or updated by the 5GC.

5. The method of claim 1, further comprising:
after establishing the transport layer protocol connection, transmitting, to the 5GC, a setup message to initiate NGAP connection setup, the setup message including information related to a spaceborne gNB; and
in response to the setup message, receiving, from the 5GC, a response message.

6. The method of claim 5, further comprising:
receiving, from the 5GC, a configuration message,
wherein the configuration message includes transport protocol layer-related information for a future NGAP connection; and
in response to the configuration message, transmitting, to the 5GC, an acknowledgment of the configuration message.

7. The method of claim 1, further comprising:
in response to the NGAP connection becoming operational or available, transmitting, to the 5GC, a message to initiate an NGAP procedure to indicate that the NGAP connection is operational or available so that the NGAP connection may be reestablished or resumed.

8. The method of claim 1, wherein the gNB is pre-configured with information indicative of a spaceborne gNB before deployment of the non-terrestrial satellite.

9. The method of claim 8, wherein the information indicative of the spaceborne gNB comprises at least a specific gNB ID that is reserved for use by spaceborne gNBs.

10. The method of claim 1, wherein the gNB is configured with information indicative of a spaceborne gNB after deployment of the non-terrestrial satellite.

11. The method of claim 1, wherein identification of the gNB by the 5GC as being a spaceborne gNB is based on pre-configured transport layer protocol-related information.

12. The method of claim 11, wherein the pre-configured transport layer protocol-related information comprises at least one of a destination IP address, a port number, or a payload protocol identifier (PPID) if Stream Control Transmission Protocol (SCTP) is used.

13. A method d comprising:
establishing, by a network node, a transport layer protocol connection to a Next Generation (NG) Node B (gNB) on board a non-terrestrial satellite for an NG Application Protocol (NGAP) connection, the NGAP connection including a physical layer connection established between the NTN gateway and the gNB; and
receiving, by the network node from the gNB, a message indicating that the NGAP connection is to become nonoperational or unavailable.

14. The method of claim 13, further comprising:
after establishing the transport layer protocol connection, receiving, from the gNB, a setup message for initiating NGAP connection setup, and
wherein the setup message comprises at least one of information indicating that the gNB is being a spaceborne gNB, at least a specific gNB ID that is reserved for use by the spaceborne gNB, or feeder link availability time.

15. The method of claim 13, further comprising:
receiving, via the NGAP connection, information indicating that the gNB is being a spaceborne gNB, and
wherein the information is received using UE-related signaling.

16. A Next Generation (NG) Node B (gNB) comprising:
at least one transceiver; and
at least one processor configured to:
establish a physical layer connection to a non-terrestrial network (NTN) gateway for an NG Application Protocol (NGAP) connection;
establish a transport layer protocol connection to a 5G core network (5GC) for the NGAP connection;
determine that the NGAP connection is to become nonoperational or unavailable; and
in response to the determination, transmit a message to indicate that the NGAP connection is to become nonoperational or unavailable.
